(19) United States
(12) Patent Application Publication
(10) Pub. No.: US 2017/0129276 A1
(43) Pub. Date: May 11, 2017

(54) SYSTEM AND METHOD FOR FABRICATING ARTWORK AND DECORATIVE ARTICLES WITH MOLDED CANNABIS PLANT PARTS

(71) Applicant: Vadim Shavlovskiy, Elverta, CA (US)

(72) Inventor: Vadim Shavlovskiy, Elverta, CA (US)

(21) Appl. No.: 15/354,922

(22) Filed: Nov. 17, 2016

(51) Int. Cl. B44C 5/06; B29C 65/48; B29C 65/02; B29C 33/40; A44C 5/00; A41G 1/00; A44C 9/00; A44C 25/00; A44C 27/00; A23G 3/02; A21B 3/13; B29C 65/56; A44C 7/00

(52) U.S. Cl. CPC B44C 5/06; B29C 65/565; B29C 65/48; B29C 65/02; B29C 33/405; A44C 5/00; A44C 7/00; A44C 9/00; A44C 25/001; A44C 27/002; A44C 25/007; A23G 3/0268; A21B 3/13; A41G 1/00; B29K 2883/00; B29L 2031/743

(57) ABSTRACT

The embodiments herein provide Cannabis plant parts (leaf, bud, flower and the like) by molding. The embodiments also provide Cannabis plant parts (leaf, bud, flower and the like) by molding for fabrication of jewelry and decorative articles. The 3D molded Cannabis bud, the 3D molded Cannabis leaves and the 3D molded Cannabis flower are fabricated from the material selected from a group consisting of plastics, polymers, glass, rubber, precious metals and non-precious metals. The metals are selected from a group consisting of steel, aluminum, precious metals (silver, gold and platinum). The decorative structures fabricated with Cannabis plant parts (leaf, flower, bud and the like) are light lamp, key chain, Christmas ornaments, souvenir, chocolate mold, candy mold, cookies mold and muffin mold. The ornamental structures fabricated with Cannabis plant parts (leaf, flower, bud and the like) are finger ring, earring, chain pendant, bracelet charms.

### BACKGROUND

Technical Field

The present invention is generally related to an artwork. The present invention is particularly related to decorative articles or jewelry articles. The present invention is more particularly related to molding a system and method for fabricating molded plant parts such as cannabis or hemp parts for artwork and decorative articles.

Description of the Related Art

Modern life is more and more busy, and there is pursuit of enjoyment, comfort and decoration. Decoration of the surroundings and an individual's body is done by various articles or ornaments. Based on situation and occasion the surroundings and an individual's body are decorated.

A variety of crafts/articles have been developed and utilized to produce articles of jewelry and artifacts which are made of different colored components such as plastic or glass. These artifacts require the matching of the colored components with cavities formed in the base on which the colored components are applied. This procedure is tedious and frequently results in assemblies which may easily come apart.

Jewelry and more multi component integrated design in application and integration of jewelry cannot transform a variety of combination.

The aesthetic value of botanicals has long been appreciated. Botanicals, such as plants and parts of plants example: flowers, stems, seeds, leaves, vegetables, fruits etc., are commonly used for gifts, decorations, decorative articles for jewelry design and the like. Some plant or parts of plants are presented, used for decoration and worn for special occasions, which have sentimental importance. The plant parts such as flower, leaves, buds are often preferred as jewelry designs and decorative articles.

However many plants/parts of plants is hampered by their short lives, when botanicals die, they lose their pleasing appearance. Cut flowers, buds and leaves have their stems submerged in water usually survive only a few days to a several weeks, barring any further treatment. As a result much effort has been made to preserve and prolong the life of plants. Further the plant parts such as leaves, buds, flowers may not be directly worn as jewelry or kept as decorative articles due to short shelf life and size or presented as gift articles.

In order to retain fresh look or appearance of a plants/plant parts (leaves, bud or flower) appearance, a drying process is often employed to remove most of the water content in the decorative plants. The drying process is carried out by immersing the plant into a drying agent, such as a dehydrating alcohol or a desiccating substance, such as silicone fluid or gel, silicone resin, alkaline formaldehyde sulfoxylate, aluminum or magnesium sulphate and cupric or other transitional metal sulphate and ionized. In addition the plants/plant parts (leaves, bud or flower) may be frozen dried or exposed to low humidity air. Dehydration may take place by exposure to vacuum pressure such as 100 mm Hg. Also the drying process causes the plants/plant parts (leaves, bud or flower) to become extremely brittle, fragile and highly susceptible to damage in extremes of temperature or humidity. Special handling and storage techniques of the dried plants are required. The dried plants/plant parts (leaves, bud or flower) also lose the shapes by drastically shrinking in size and curling of tissues such as leaves and petals. Furthermore the natural colors or pigments of the plants are faded during dehydration. The natural beauty of the plants/plant parts (leaves, bud or flower) is lost and their value as decorative articles is reduced. Further the dried plant parts such as leaves, buds, flowers may not be directly worn as jewelry or kept as decorative articles or presented as gift articles due to dried appearance, brittle nature and unattractive appearance.

Glycerol infusion frequently results in bleeding or weeping the solution from the plant surface, especially in environments of high humidity. Such humectants also may cause color changes in the plant.

A thin clear coat barrier of film may be added to the plant surface to prevent leakage of dye and humectants. In still other approaches, an acrylic polymer film that permits moisture transmission is located over the plant. The film has sufficient oxygen and carbon dioxide permeability to support respiration of the plants.

Although these methods extend the life of plant/parts of plant, the resulting plant/parts of plant are not durable and permanent articles. Even with a thin covering the plants remains susceptible to breakage and fluctuations in environmental temperature and humidity.

Cannabis sativa and Cannabis indica are annual herbaceous plants in the Cannabis genus, a species of the Cannabaceae family. The Cannabis sativa and Cannabis indica have leaves, fruits and buds of attractive shapes and size. Direct use of Cannabis sativa and Cannabis indica leaves, fruits and buds for ornamental purpose or decorative purpose is difficult, as the plant parts (leaves, buds, flower and the like) get dried. Further the natural Cannabis sativa and Cannabis indica leaves, fruits and buds cannot be worn as ornaments or kept as decoration articles.

Hence, there is need for a method for creating permanent plant parts (leaf, bud, flower and the like) that sustain or endure drastic environmental condition and withstand substantial pressure. Also there is need for fabricating plant parts such as leaf, bud, flower and the like to use as designer jewelry or article.

The above mentioned shortcomings, disadvantages and problems are addressed herein and which will be understood by reading and studying the following specification.

### OBJECTIVES OF THE EMBODIMENTS

The primary objective of the embodiment herein is to produce Cannabis plant parts (leaf, bud, flower and the like) by molding.

Another objective of the embodiment herein is to provide Cannabis plant parts (leaf, bud, flower and the like) by molding for fabrication of jewelry and decorative articles.

Yet another objective of the embodiment herein is to provide an easy molding method for the fabrication of Cannabis plant parts (leaf, bud, flower and the like).

Yet another objective of the embodiment herein is to provide the Cannabis plant parts (leaf, bud, flower and the like) for the fabrication of ornaments selected from a group consisting of finger ring, earring, chain pendant, bracelet charms.

Yet another objective of the embodiment herein is to provide the Cannabis plant parts (leaf, bud, flower and the like) for the fabrication of decoration articles selected from a group consisting of light lamp, key chain, Christmas ornaments, souvenir, chocolate mold, candy mold, cookies mold, muffin mold.

These and other objects and advantages of the present invention will become readily apparent from the following detailed description taken in conjunction with the accompanying drawings.

### SUMMARY

The various embodiments herein provide Cannabis plant parts (leaf, bud, flower and the like) by molding. The embodiments also provide Cannabis plant parts (leaf, bud, flower and the like) by molding for fabrication of jewelry and decorative articles.

According to one embodiment herein, the 3D molded article of manufacture comprises a 3D molded bud of a plant, a 3D molded flower of the plant and a plurality of 3D molded leaves of the plant. The 3D molded bud of the plant, the 3D molded flower of the plant and the plurality of 3D molded leaves of the plant are assembled to form decorative articles or structures and ornamental articles or jewelry structures. The plant is a Cannabis plant or a Hemp plant. The 3D molded Cannabis bud is selected from a group consisting of two piece hollow Cannabis bud and a one piece solid Cannabis bud. The 3D molded Cannabis bud, the 3D molded Cannabis flower and the 3D molded Cannabis leaves are configured with an internal pin comprising an eyelet or pinhole. The article obtained after fastening or joining the 3D molded bud of the plant, the 3D molded flower of the plant and the plurality of 3D molded leaves of the plant is configured with an internal pin comprising an eyelet or pinhole.

According to one embodiment herein, the 3D molded bud of the plant, the 3D molded flower of the plant and the plurality of 3D molded leaves of the plant are molded or fabricated from one or more materials selected from a group consisting of polymer, glass, rubber, silicone, clay, porcelain, wax, steel, pewter, aluminum, bronze, copper, precious metals (silver, gold and platinum). The materials are added in a predetermined amount for molding. The predetermined amount of materials is in a range of 1 gram-5000 grams.

According to one embodiment herein, the decorative articles are selected from a group consisting of light lamp, key chain, Christmas ornaments, souvenir articles, chocolate mold, candy mold, cookies mold and muffin mold. The Christmas ornaments are suspended or hanged in plurality of ways selected from a group consisting of hook, string. The hook and string are attached to the bud comprising pinhole.

According to one embodiment herein, the ornamental articles or jewelry articles are selected from a group consisting of finger ring, earring, chain pendant and bracelet charm. The 3D molded Cannabis bud earring comprises a hollow one piece or single piece bud.

According to one embodiment herein, the two piece hollow buds of the plant are attached or joined by a fastening mechanism selected from a group consisting of screw mechanism, hinged clip mechanism, snap on mechanism and push fit mechanism.

According to one embodiment herein, the 3D molded bud of the plant, the 3D molded flower of the plant and the plurality of 3D molded leaves of the plant have an internal pin comprising eyelet or pinhole for configuring the internal pin to decorative article or jewelry articles. The internal pin is fabricated from plastic or metal. The dimension of internal pin is in a range of 0.5 inch-1.5 inch.

According to one embodiment herein, the 3D molded bud of the plant, the 3D molded flower of the plant and the plurality of 3D molded leaves of the plant are fastened or attached by a method selected from a group consisting of welding and adhesive agent.

According to one embodiment herein, the method of fabricating 3D molded article, comprises the following steps. The bud of a plant is molded, the flower of the plant is molded and the plurality of leaves of the plant are molded. A silicone rubber mold or a vulcanized back rubber mold is used for fabricating the bud of the plant, the flower of the plant and the plurality of the leaves of the plant. The 3D molded bud of the plant, the 3D molded flower of the plant and the plurality of 3D molded leaves of the plant are assembled to form decorative articles or structures and ornamental articles or jewelry structures, and wherein the plant is a Cannabis plant or a Hemp plant, and wherein the 3D molded Cannabis bud is selected from a group consisting of two piece hollow Cannabis bud and a one piece solid Cannabis bud. The 3D molded Cannabis bud, the 3D molded Cannabis flower and the 3D molded Cannabis leaves are configured with an internal pin comprising an eyelet or pinhole. The article obtained after fastening or joining the 3D molded bud of the plant, the 3D molded flower of the plant and the plurality of 3D molded leaves of the plant is configured with an internal pin comprising an eyelet or pinhole.

According to one embodiment herein, the 3D molded bud of the plant, the 3D molded flower of the plant and the plurality of 3D molded leaves of the plant are molded or fabricated from one or more materials selected from a group consisting of polymer, glass, rubber, silicone, clay, porcelain, wax, steel, pewter, aluminum, bronze, copper, precious metals (silver, gold and platinum). The materials are added in a predetermined amount for molding, and wherein the predetermined amount of materials is in a range of 1 gram-5000 grams.

According to one embodiment herein, the decorative articles are selected from a group consisting of light lamp, key chain, Christmas ornaments, souvenir articles, chocolate mold, candy mold, cookies mold and muffin mold. The Christmas ornaments are suspended or hanged in plurality of ways selected from a group consisting of hook, string. The hook and string are attached to the bud comprising pinhole.

According to one embodiment herein, the ornamental articles or jewellery articles are selected from a group consisting of finger ring, earring, chain pendant and bracelet charm. The 3D molded Cannabis bud earring comprises a hollow one piece or single piece bud.

According to one embodiment herein, the two piece hollow buds of the plant are attached or joined by a fastening mechanism selected from a group consisting of screw mechanism, hinged clip mechanism, snap on mechanism and push fit mechanism.

According to one embodiment herein, 3D molded bud of the plant, the 3D molded flower of the plant and the plurality of 3D molded leaves of the plant have an internal pin comprising eyelet or pinhole for configuring the internal pin to decorative article or jewellery articles. The internal pin is fabricated from plastic or metal. The dimension of internal pin is in a range of 0.5 inch-1.5 inch.

According to one embodiment herein, the 3D molded bud of the plant, the 3D molded flower of the plant and the plurality of 3D molded leaves of the plant are fastened or attached by a method selected from a group consisting of welding and adhesive agent.

According to one embodiment herein, for the fabrication of Cannabis plant parts (leaf, bud, flower and the like) the materials required are polymers, glass, rubber, silicone, clay, porcelain, wax (different types of waxes), steel, pewter, aluminum, bronze, copper, precious metals (silver, gold and platinum).

According to one embodiment herein, the materials are added in predetermined amount. The predetermined amount is in a range of 1 gram-5 kilograms.

According to one embodiment herein, the method utilized for the fabrication of Cannabis plant parts (leaf, bud, flower and the like) is selected from a group consisting of injection molding, spin molding, blow molding, glass molding.

According to one embodiment herein, the silicone rubber mold or vulcanized black rubber mold are used for fabrication of Cannabis plant parts (leaf, flower, bud and the like).

According to one embodiment herein, after the Cannabis leaves are fabricated by molding process, the leaves are glued or welded together. The glued or welded Cannabis leaves are again glued or welded to the bottom of the Cannabis flower. The Cannabis flower is also fabricated by the molding process.

According to one embodiment herein, after joining or adhering the molded Cannabis leaves and flower a decorative/ornamental structure is obtained. The decorative articles/structures fabricated with Cannabis plant parts (leaf, flower, bud and the like) are light lamp, key chain, Christmas ornaments, souvenir, chocolate mold, candy mold, cookies mold and muffin mold. The Christmas ornaments are suspended or hanged in plurality of ways selected from a group consisting of hook, string. The hook and string are attached to the bud comprising pinhole.

The ornamental articles/structures fabricated with Cannabis plant parts (leaf, flower, bud and the like) are finger ring, earring, chain pendant, bracelet charms. The 3D molded Cannabis bud earring comprises a hollow one piece or single piece bud.

According to one embodiment herein, the Cannabis bud is fabricated in two forms: (a) two piece hollow Cannabis bud and (b) one piece solid Cannabis bud.

According to one embodiment herein, the two piece Cannabis hollow bud are attached or joined to each other by screw mechanism, hinged clip mechanism and snap-on mechanism or push fit mechanism.

According to one embodiment herein, an internal pin is also molded in the Cannabis bud. The internal pin is fabricated from metal or plastic. The internal pin comprises a circular hole on one side for configuring additional components for fabrication of jewelry or decorative articles. The internal pin is configured to the top of the Cannabis bud. The function of the internal pin is to hold key chain, chains, ribbons. The internal pin is fabricated from plastic or metal. The dimension of internal pin is in a range of 0.5 inch to 1.5 inch.

According to one embodiment herein, the fabricated Cannabis leaf and bud are adhered or configured together by a method selected from a group consisting of welding and adhesive medium.

According to one embodiment herein, a plurality of the fabricated molded Cannabis leaves are attached/adhered based on choice. The joined Cannabis leaves are attached on ear ring loop, finger rings and based on preference or user or wearer.

According to one embodiment herein, the injection molding yields one piece solid Cannabis bud (one piece 3D molded Cannabis bud) with pin inside. The spin molding and blow molding yields one piece solid Cannabis bud (one piece 3D molded Cannabis bud).

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a photograph indicating a 3D molded Cannabis bud in a single piece form, according to one embodiment herein.

FIG. 2 illustrates a photograph indicating a 3D molded Cannabis bud in single piece form configured to a key chain, according to one embodiment herein.

FIG. 3A, FIG. 3B and FIG. 3C illustrate a photograph indicating a 3D molded Cannabis bud in a two piece form, according to one embodiment herein.

FIG. 4 illustrates a photograph indicating a 3D molded Cannabis leaf, according to one embodiment herein.

FIG. 5 illustrates an internal pin and eyelet (pinhole) system for configuring to a 3D molded Cannabis leaf, according to one embodiment herein.

FIG. 6 illustrates 3D molded Cannabis leaves joined or configured together, according to one embodiment herein.

FIG. 7A and FIG. 7B illustrate photographs indicating the 3D molded Cannabis leaves configured together, according to one embodiment herein.

FIG. 8 illustrates a top side view of an ornamental 3D molded Cannabis bud, according to one embodiment herein.

FIG. 9 illustrates a bottom side perspective view of an ornamental 3D molded Cannabis bud, according to one embodiment herein.

FIG. 10 illustrates a rear side perspective view of an ornamental 3D molded Cannabis bud, according to one embodiment herein.

FIG. 11 illustrates a rear side perspective view of an ornamental 3D molded Cannabis bud, according to one embodiment herein.

FIG. 12 A, FIG. 12B and FIG. 12C illustrates a 3D molded Cannabis bud as lamp shade, according to one embodiment herein.

FIG. 13 illustrates photograph indicating the 3D molded Cannabis leaf configured with an eyehole or pinhole, according to one embodiment herein.

FIG. 14 illustrates photograph indicating the bracelet configured with a Cannabis decorative article comprising a 3D molded Cannabis bud and Cannabis leaves, according to one embodiment herein.

FIG. 15 illustrates photograph indicating a mold in a shape of Cannabis bud and Cannabis leaves, according to one embodiment herein.

FIG. 16A and FIG. 16B illustrate an ornamental pendant comprising 3D molded Cannabis bud and Cannabis leaves, according to one embodiment herein.

FIG. 17 illustrates an ornamental earring comprising 3D molded Cannabis bud and Cannabis leaves, according to one embodiment herein.

FIG. 18A, FIG. 18B and FIG. 18C illustrates different views of an ornamental finger ring comprising 3D molded Cannabis bud and Cannabis leaves, according to one embodiment herein.

FIG. 19 illustrates a key chain comprising 3D molded Cannabis leaves, according to one embodiment herein.

Although the specific features of the present invention are shown in some drawings and not in others. This is done for convenience only as each feature may be combined with any or all of the other features in accordance with the present invention.

### DETAILED DESCRIPTION OF THE EMBODIMENTS

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide Cannabis plant parts (leaf, bud, flower and the like) by molding. The embodiments also provide Cannabis plant parts (leaf, bud, flower and the like) by molding for fabrication of jewelry and decorative articles.

According to one embodiment herein, the 3D molded article of manufacture comprises a 3D molded bud of a plant, a 3D molded flower of the plant and a plurality of 3D molded leaves of the plant. The 3D molded bud of the plant, the 3D molded flower of the plant and the plurality of 3D molded leaves of the plant are assembled to form decorative articles or structures and ornamental articles or jewellery structures. The plant is a Cannabis plant or a Hemp plant. The 3D molded Cannabis bud is selected from a group consisting of two piece hollow Cannabis bud and a one piece solid Cannabis bud. The 3D molded Cannabis bud, the 3D molded Cannabis flower and the 3D molded Cannabis leaves are configured with an internal pin comprising an eyelet or pinhole. The article obtained after fastening or joining the 3D molded bud of the plant, the 3D molded flower of the plant and the plurality of 3D molded leaves of the plant is configured with an internal pin comprising an eyelet or pinhole.

According to one embodiment herein, the 3D molded bud of the plant, the 3D molded flower of the plant and the plurality of 3D molded leaves of the plant are molded or fabricated from one or more materials selected from a group consisting of polymer, glass, rubber, silicone, clay, porcelain, wax, steel, pewter, aluminium, bronze, copper, precious metals (silver, gold and platinum). The materials are added in a predetermined amount for molding. The predetermined amount of materials is in a range of 1 gram-5000 grams.

According to one embodiment herein, the decorative articles are selected from a group consisting of light lamp, key chain, Christmas ornaments, souvenir articles, chocolate mold, candy mold, cookies mold and muffin mold. The Christmas ornaments are suspended or hanged in plurality of ways selected from a group consisting of hook, string. The hook and string are attached to the bud comprising pinhole.

According to one embodiment herein, the ornamental articles or jewelry articles are selected from a group consisting of finger ring, earring, chain pendant and bracelet charm. The 3D molded Cannabis bud earring comprises a hollow one piece or single piece bud.

According to one embodiment herein, the two piece hollow buds of the plant are attached or joined by a fastening mechanism selected from a group consisting of screw mechanism, hinged clip mechanism, snap on mechanism and push fit mechanism.

According to one embodiment herein, the 3D molded bud of the plant, the 3D molded flower of the plant and the plurality of 3D molded leaves of the plant have an internal pin comprising eyelet or pinhole for configuring the internal pin to decorative article or jewellery articles. The internal pin is fabricated from plastic or metal. The dimension of internal pin is in a range of 0.5 inch-1.5 inch.

According to one embodiment herein, the 3D molded bud of the plant, the 3D molded flower of the plant and the plurality of 3D molded leaves of the plant are fastened or attached by a method selected from a group consisting of welding and adhesive agent.

According to one embodiment herein, the method of fabricating 3D molded article, comprises the following steps. The bud of a plant is molded, the flower of the plant is molded and the plurality of leaves of the plant are molded. A silicone rubber mold or a vulcanized back rubber mold is used for fabricating the bud of the plant, the flower of the plant and the plurality of the leaves of the plant. The 3D molded bud of the plant, the 3D molded flower of the plant and the plurality of 3D molded leaves of the plant are assembled to form decorative articles or structures and ornamental articles or jewellery structures, and wherein the plant is a Cannabis plant or a Hemp plant, and wherein the 3D molded Cannabis bud is selected from a group consisting of two piece hollow Cannabis bud and a one piece solid Cannabis bud. The 3D molded Cannabis bud, the 3D molded Cannabis flower and the 3D molded Cannabis leaves are configured with an internal pin comprising an eyelet or pinhole. The article obtained after fastening or joining the 3D molded bud of the plant, the 3D molded flower of the plant and the plurality of 3D molded leaves of the plant is configured with an internal pin comprising an eyelet or pinhole.

According to one embodiment herein, the 3D molded bud of the plant, the 3D molded flower of the plant and the plurality of 3D molded leaves of the plant are molded or fabricated from one or more materials selected from a group consisting of polymer, glass, rubber, silicone, clay, porcelain, wax, steel, pewter, aluminum, bronze, copper, precious metals (silver, gold and platinum). The materials are added in a predetermined amount for molding, and wherein the predetermined amount of materials is in a range of 1 gram-5000 grams.

According to one embodiment herein, the decorative articles are selected from a group consisting of light lamp, key chain, Christmas ornaments, souvenir articles, chocolate mold, candy mold, cookies mold and muffin mold. The Christmas ornaments are suspended or hanged in plurality of ways selected from a group consisting of hook, string. The hook and string are attached to the bud comprising pinhole.

According to one embodiment herein, the ornamental articles or jewellery articles are selected from a group consisting of finger ring, earring, chain pendant and bracelet charm. The 3D molded Cannabis bud earring comprises a hollow one piece or single piece bud.

According to one embodiment herein, the two piece hollow buds of the plant are attached or joined by a fastening mechanism selected from a group consisting of screw mechanism, hinged clip mechanism, snap on mechanism and push fit mechanism.

According to one embodiment herein, 3D molded bud of the plant, the 3D molded flower of the plant and the plurality of 3D molded leaves of the plant have an internal pin comprising eyelet or pinhole for configuring the internal pin to decorative article or jewellery articles. The internal pin is fabricated from plastic or metal. The dimension of internal pin is in a range of 0.5 inch-1.5 inch.

According to one embodiment herein, the 3D molded bud of the plant, the 3D molded flower of the plant and the plurality of 3D molded leaves of the plant are fastened or attached by a method selected from a group consisting of welding and adhesive agent.

According to one embodiment herein, for the fabrication of Cannabis plant parts (leaf, bud, flower and the like) the materials required are polymers, glass, rubber, silicone, clay, porcelain, wax (different types of waxes), steel, pewter, aluminum, bronze, copper, precious metals (silver, gold and platinum).

According to one embodiment herein, the materials are added in predetermined amount. The predetermined amount is in a range of 1 gram-5 kilograms.

According to one embodiment herein, the method utilized for the fabrication of Cannabis plant parts (leaf, bud, flower and the like) is selected from a group consisting of injection molding, spin molding, blow molding, glass molding.

According to one embodiment herein, the silicone rubber mold or vulcanized black rubber mold are used for fabrication of Cannabis plant parts (leaf, flower, bud and the like).

According to one embodiment herein, after the Cannabis leaves are fabricated by molding process, the leaves are glued or welded together. The glued or welded Cannabis leaves are again glued or welded to the bottom of the Cannabis flower. The Cannabis flower is also fabricated by the molding process.

According to one embodiment herein, after joining or adhering the molded Cannabis leaves and flower a decorative/ornamental structure is obtained. The decorative structures fabricated with Cannabis plant parts (leaf, flower, bud and the like) are light lamp, key chain, Christmas ornaments, souvenir, chocolate mold, candy mold, cookies mold and muffin mold. The Christmas ornaments are suspended or hanged in plurality of ways selected from a group consisting of hook, string. The hook and string are attached to the bud comprising pinhole.

The ornamental structures fabricated with Cannabis plant parts (leaf, flower, bud and the like) are finger ring, earring, chain pendant, bracelet charms. The 3D molded Cannabis bud earring comprises a hollow one piece or single piece bud.

According to one embodiment herein, the Cannabis bud is fabricated in two forms: (a) two piece hollow Cannabis bud and (b) one piece solid Cannabis bud.

According to one embodiment herein, the two piece Cannabis hollow bud are attached or joined to each other by screw mechanism, hinged clip mechanism and snap-on mechanism or push fit mechanism.

According to one embodiment herein, an internal pin is also molded in the Cannabis bud. The internal pin is fabricated from metal or plastic. The internal pin comprises a circular hole on one side for configuring additional components for fabrication of jewelry or decorative articles. The internal pin is configured to the top of the Cannabis bud. The function of the internal pin is to hold key chain, chains, ribbons. The internal pin is fabricated from plastic or metal. The dimension of internal pin is in a range of 0.5 inch to 1.5 inch.

According to one embodiment herein, the fabricated Cannabis leaf and buds are adhered or configured together by a method selected from a group consisting of welding and adhesive medium.

According to one embodiment herein, a plurality of the fabricated molded Cannabis leaves are attached/adhered based on choice. The joined Cannabis leaves are attached on ear ring loop, finger rings and based on preference or user or wearer.

According to one embodiment herein, the injection molding yields one piece solid Cannabis bud (one piece 3D molded Cannabis bud) with pin inside. The spin molding and blow molding yields one piece solid Cannabis bud.

According to one embodiment herein, the 3D molded Cannabis bud including 3D molded Cannabis leaves or separately attached 3D molded Cannabis leaves are fabricated in plurality of sizes. The 3D molded Cannabis bud and leaves are used as decorative articles, design application and jewelry articles. Based on user preference the 3D molded Cannabis bud and leaves are also fabricated with materials to provide a glow in the dark. The molding process for fabricating the 3D Cannabis leaves and 3D molded Cannabis bud are injection molding, spin molding, blow molding, glass blow molding. The 3D molded Cannabis bud is molded from one piece or plurality of pieces depending on the function. The 3D molded Cannabis bud is fabricated as a one piece solid bud (one piece 3D molded Cannabis bud), one piece hollow bud and two piece hollow bud. The two piece hollow bud comprises a hollow molded top piece and a hollow molded bottom piece. The molded top piece and the molded bottom piece of the 3D molded hollow bud are attached by devices selected from a group consisting of screw, hinged clip, snap on and the like.

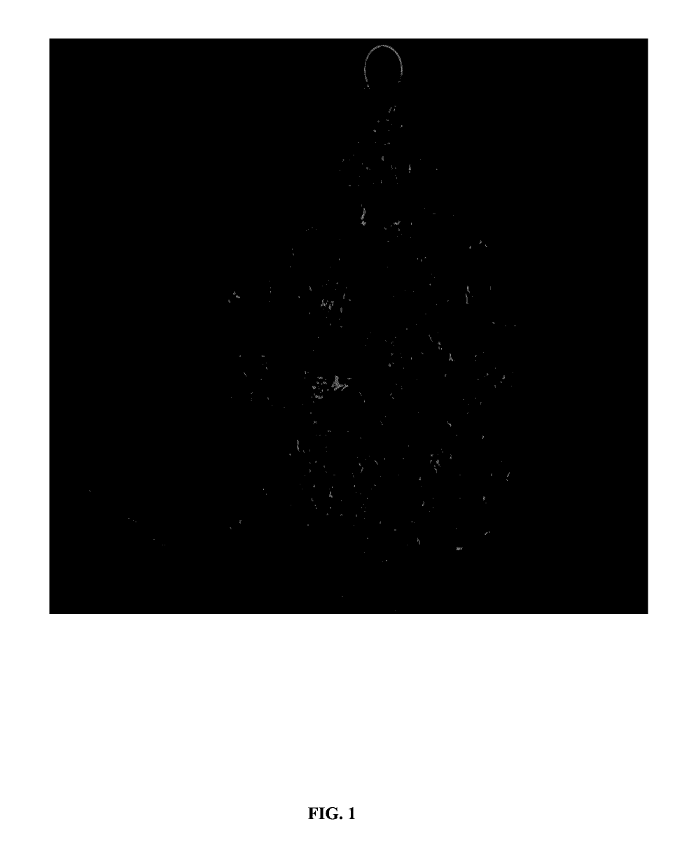

FIG. 1 is a photograph illustrating a 3D molded Cannabis bud in a single piece form, according to one embodiment herein. The 3D molded Cannabis bud is fabricated with an internal pin or without an internal pin. The 3D molded Cannabis bud consists of previous and non-precious stones or does not consists of precious and non-precious stones.

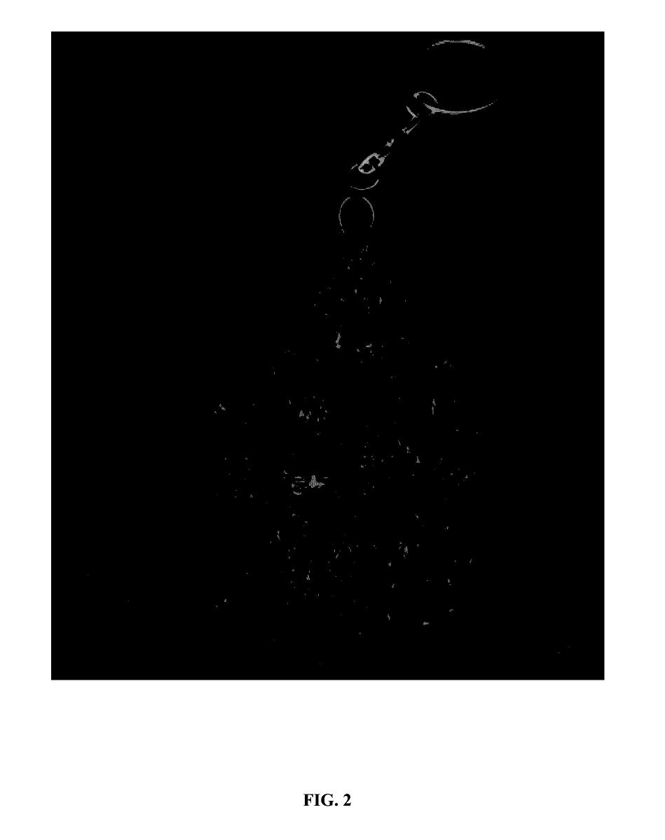

FIG. 2 is a photograph illustrating a 3D molded Cannabis bud in single piece form configured to a key chain, according to one embodiment herein. The 3D molded Cannabis bud consist of internal pin with an eyelet (pinhole). The internal pin and eyelet (pinhole) are fabricated along with 3D molded Cannabis bud or attached/configured to 3D molded Cannabis bud separately. The eyelet (pinhole) is attached with internal pin. The eyelet (pinhole) is attached/configured to key chains, pendants and the like. The eyelet (pinhole) can be inserted after fabrication of the 3D molded Cannabis bud.

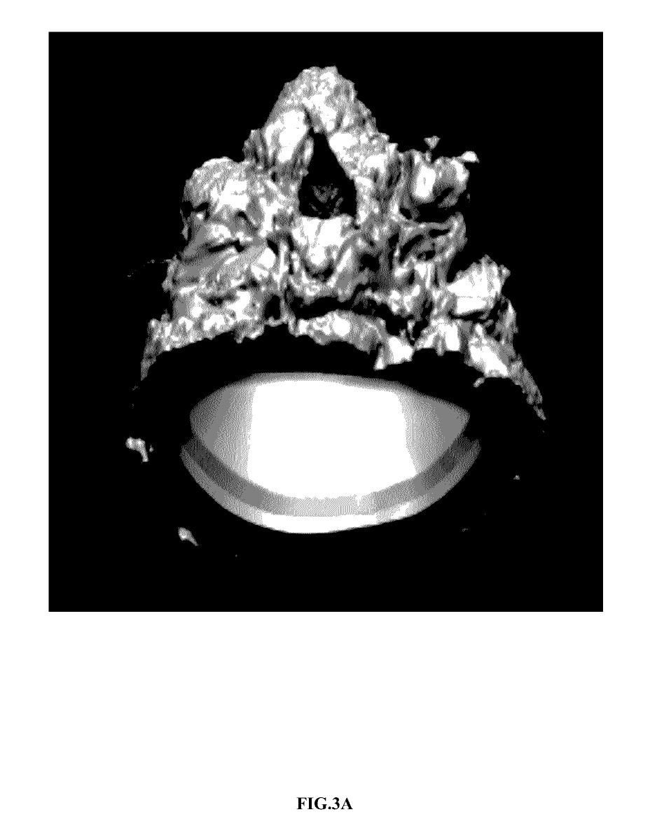

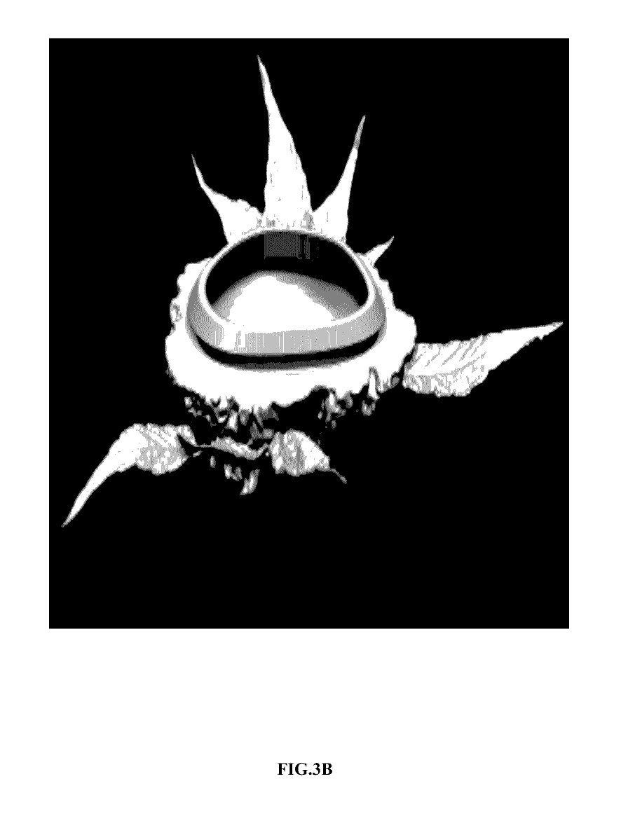

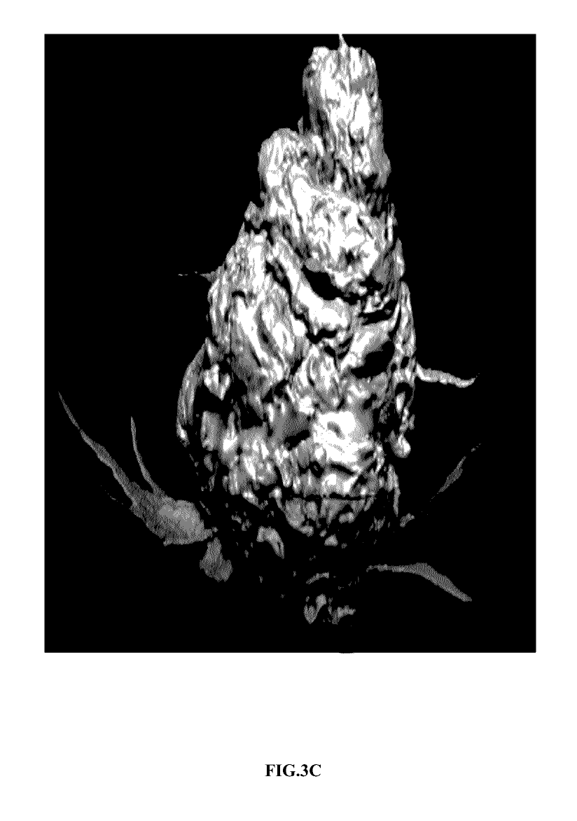

FIG. 3A, FIG. 3B and FIG. 3C are photographs illustrating a 3D molded Cannabis bud in a two piece form, according to one embodiment herein. The 3D molded Cannabis bud is a two piece form is fabricated with an internal pin or without an internal pin. The 3D molded Cannabis bud in a two piece form consists of precious and non-precious stones. FIG. 3C illustrates 3D molded Cannabis bud configured to Cannabis leaves.

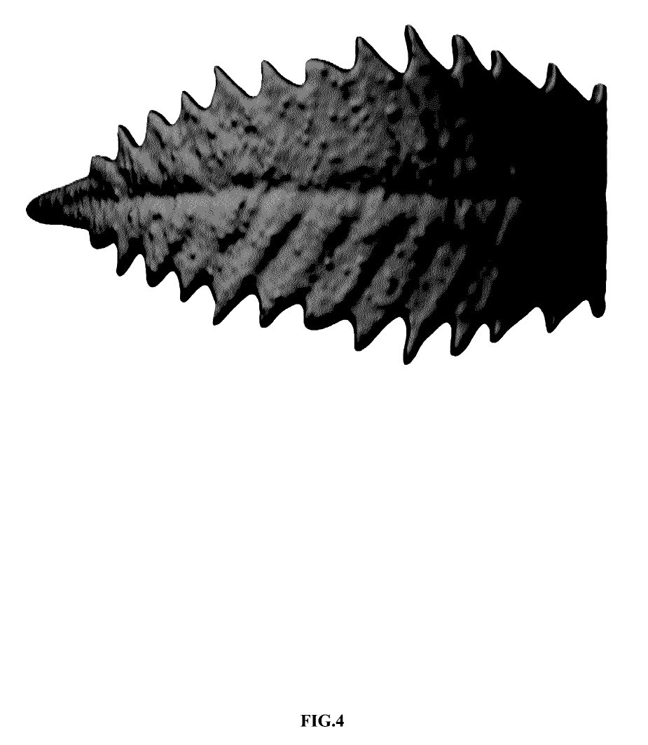

FIG. 4 is a photograph illustrating a 3D molded Cannabis leaf, according to one embodiment herein. The 3D molded Cannabis leaves are fabricated in plurality of sizes based on user preferences and article to be fabricated. The 3D molded Cannabis leaf consists of precious and non precious stones or does not consists of precious and non precious stones.

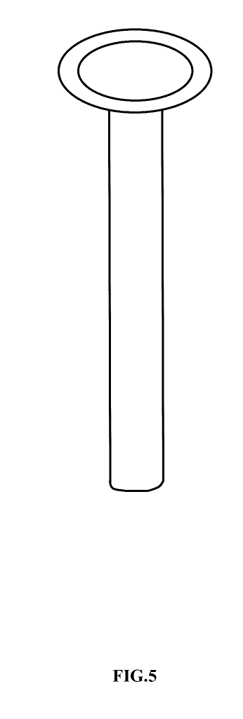

FIG. 5 illustrates an internal pin and eyelet (pinhole) system for configuring to a 3D molded Cannabis leaf, according to one embodiment herein. The internal pin is fabricated from plurality of plastics or plurality of metals. The dimension of internal pin is 0.5 inches to 1.5 inches. The internal pin is fabricated in various size and material based on user preferences.

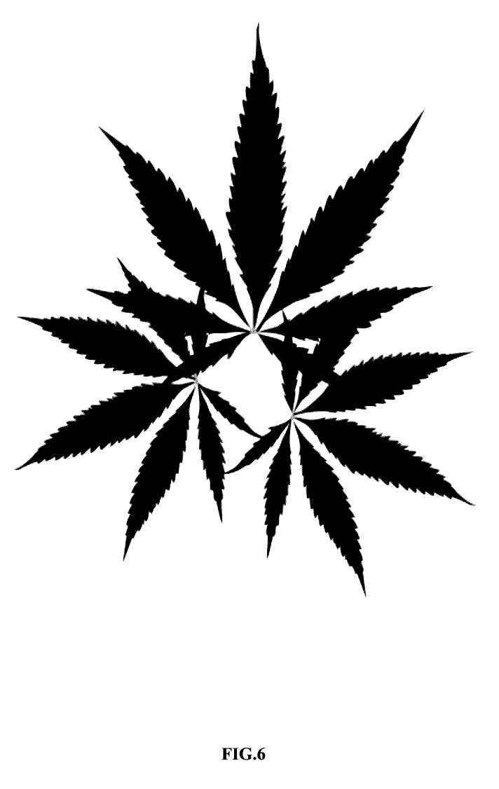

FIG. 6 illustrates 3D molded Cannabis leaves joined or configured together, according to one embodiment herein. The 3D Cannabis leaves are attached and configured together to obtain a flower pattern.

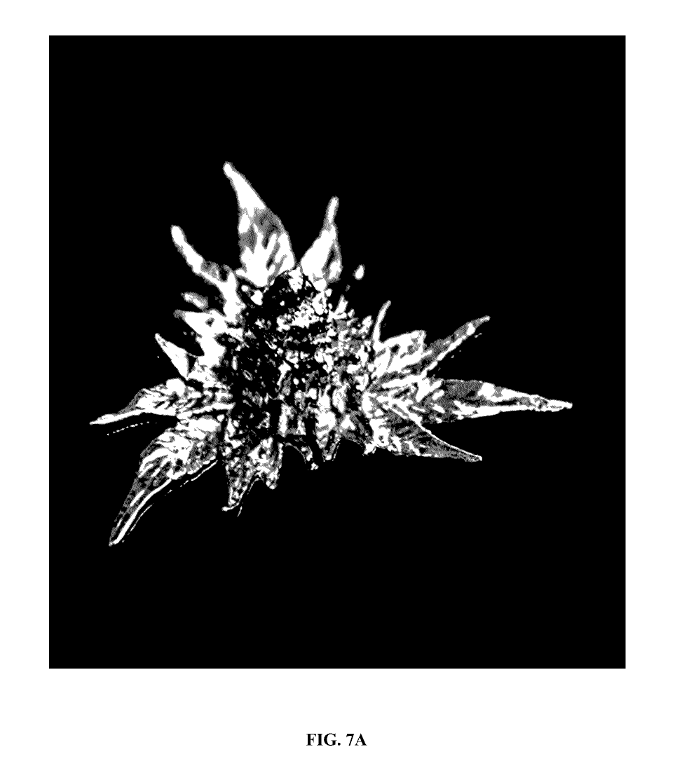

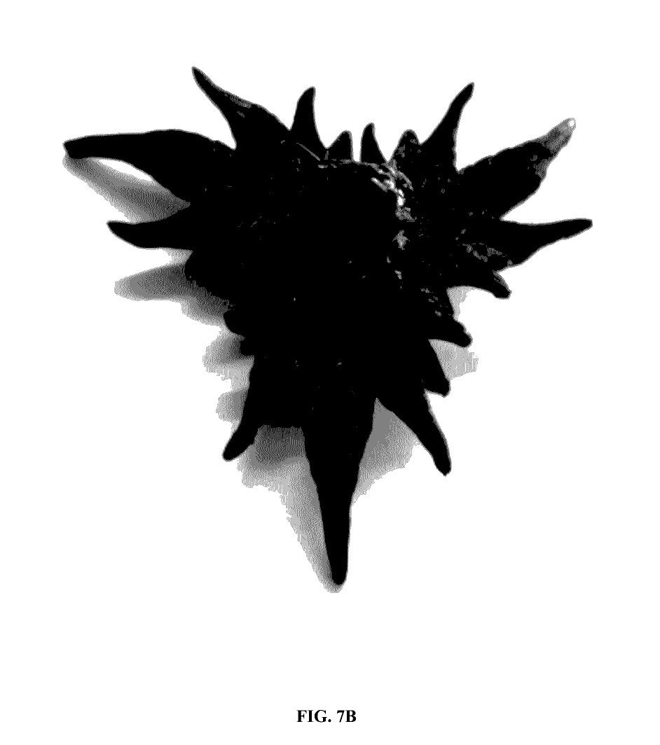

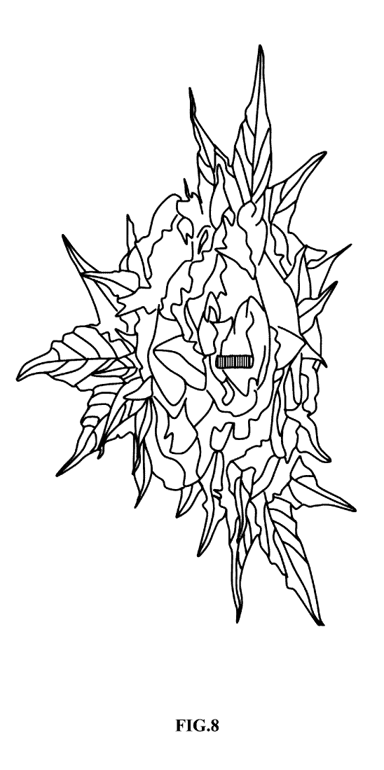

FIG. 7A and FIG. 7B are photographs illustrating the 3D molded Cannabis leaves configured together, according to one embodiment herein. The 3D molded Cannabis bud and 3D molded Cannabis leaves are configured or attached to each other to obtain a flower pattern. The 3D molded Cannabis bud and 3D Cannabis leaves are configured to decorative article and jewelry articles. The decorative structures fabricated with Cannabis leaf are light lamp, key chain, Christmas ornaments, souvenir, chocolate mold, candy mold, cookies mold and muffin mold. The Christmas ornaments are suspended or hanged in plurality of ways selected from a group consisting of hook, string. The hook and string are attached to the bud comprising pinhole.

The ornamental structures fabricated with Cannabis leaf are finger ring, earring, chain pendant, bracelet charms. The 3D molded Cannabis bud earring comprises a hollow one piece or single piece bud.

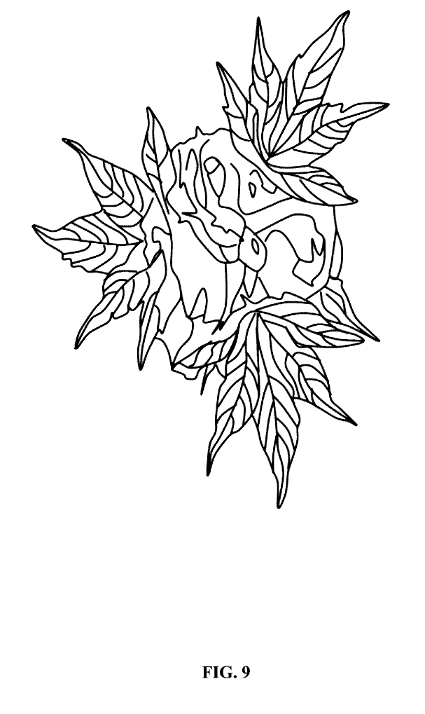

FIG. 8 illustrates a top side view of an ornamental 3D molded Cannabis bud, according to one embodiment herein. FIG. 8 illustrates an eyehole or pinhole for configuring the 3D molded design to decorative articles or jewellery articles.

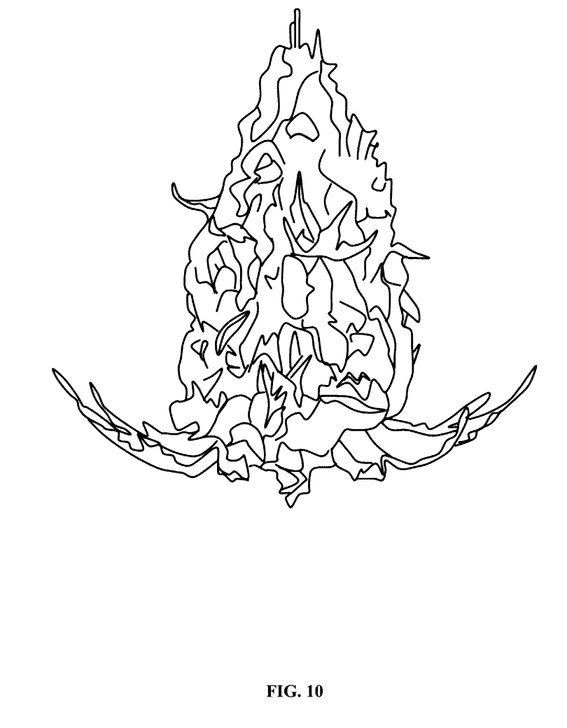

FIG. 9 illustrates a bottom side perspective view of an ornamental 3D molded Cannabis bud, according to one embodiment herein. FIG. 9 further illustrates the leaf arranged in a form of floral pattern, present at bottom side of the 3D molded Cannabis bud.

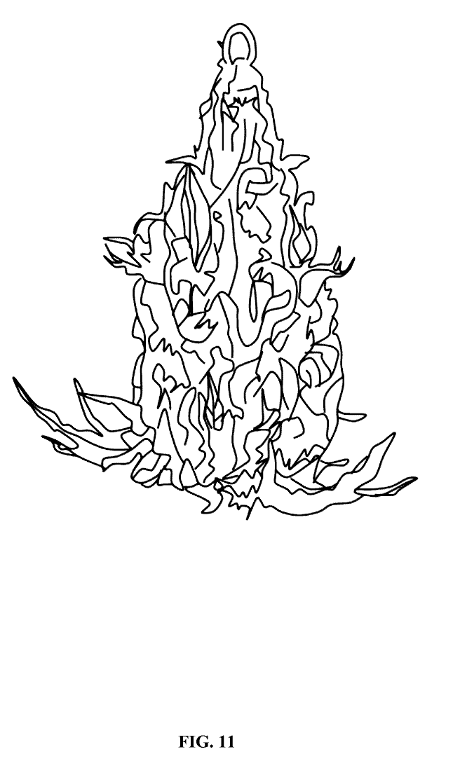

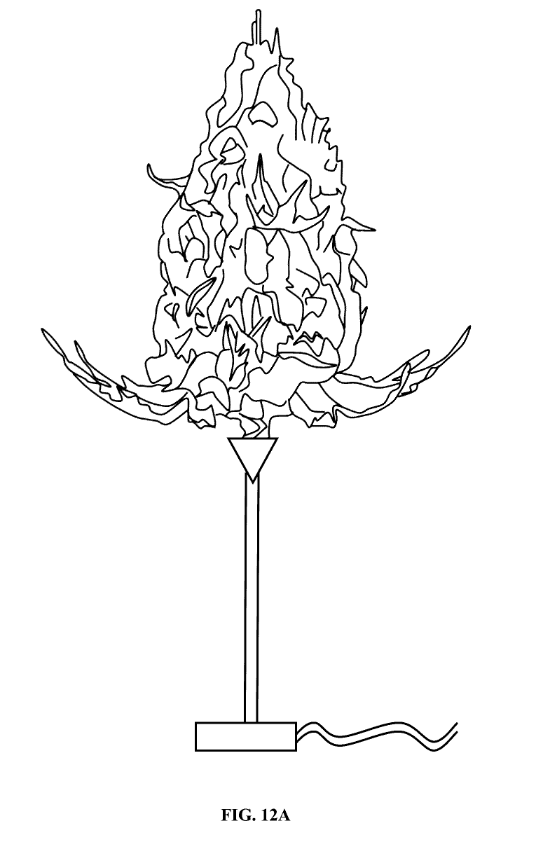

FIG. 10 illustrates a rear side perspective view of an ornamental 3D molded Cannabis bud, according to one embodiment herein. FIG. 10 illustrates an eyehole or pinhole for configuring the 3D molded Cannabis bud to decorative articles or jewellery articles.

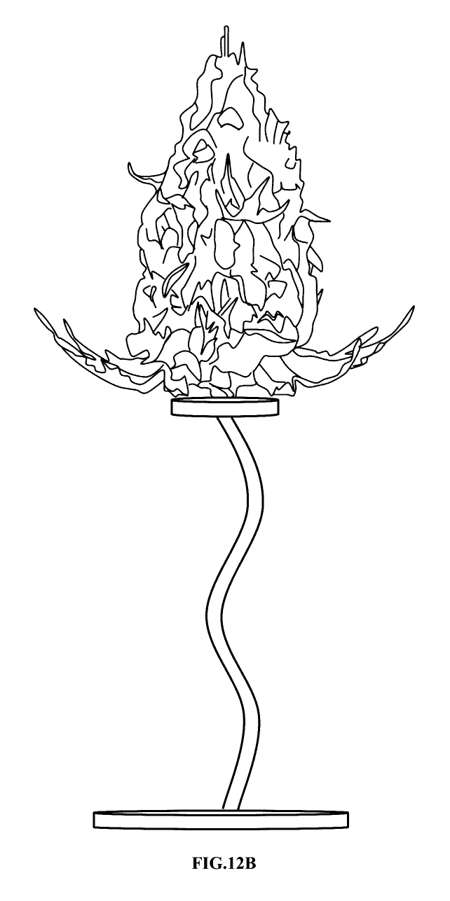

FIG. 11 illustrates a rear side perspective view of an ornamental 3D molded Cannabis bud, according to one embodiment herein. FIG. 11 illustrates an eyehole or pinhole for configuring the 3D molded Cannabis bud to decorative articles or jewellery articles.

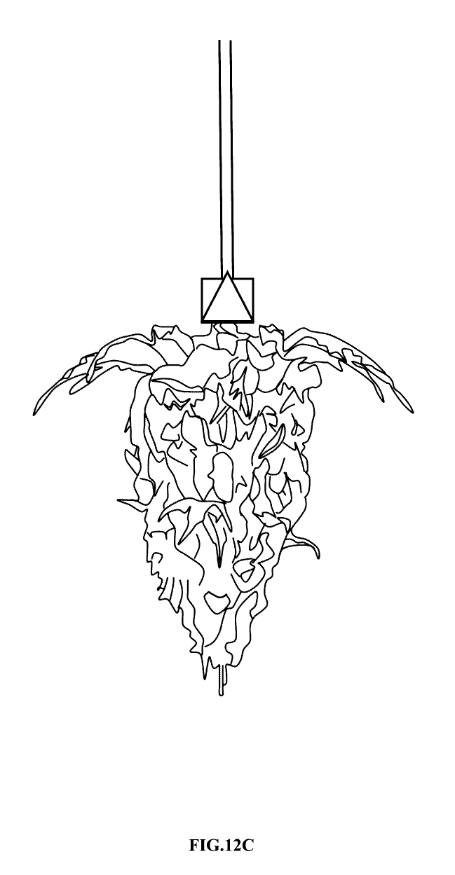

FIG. 12A-12C illustrates a 3D molded Cannabis bud as lamp shade, according to one embodiment herein. FIG. 12A illustrates a lamp shade comprising 3D molded Cannabis bud configured to 3D molded Cannabis leaves. The lamp shade is configured to a vertical lamp stand. FIG. 12B illustrates a lamp shade comprising 3D molded Cannabis bud configured to 3D molded Cannabis leaves. The lamp shade is configured to a designer lamp stand FIG. 12C illustrates a ceiling lamp shade or hanging lamp shade comprising 3D molded Cannabis bud configured to 3D molded Cannabis leaves. FIG. 12 C illustrates that the lamp shade is configured to a hanging support to be attached to the ceiling.

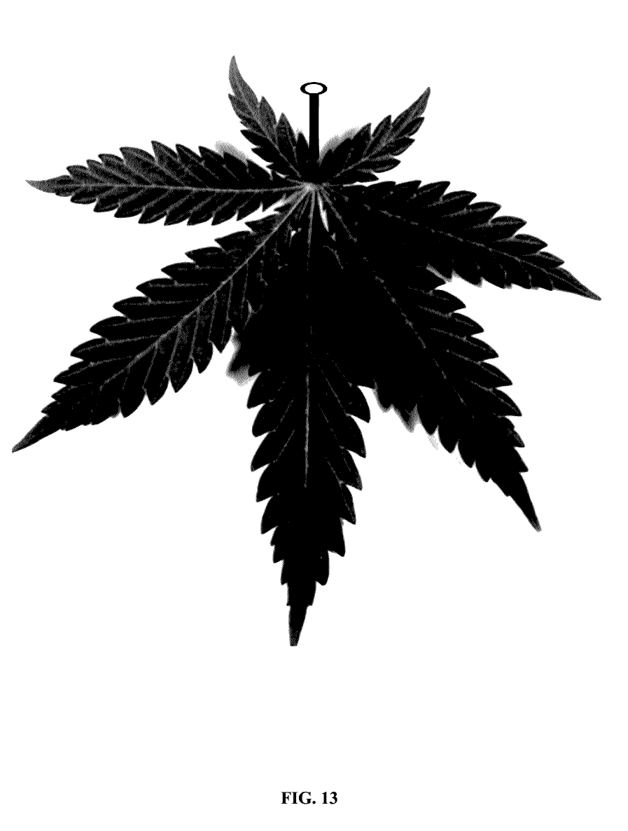

FIG. 13 illustrates photograph indicating the 3D molded Cannabis leaf configured with an eyehole or pinhole, according to one embodiment herein. The Cannabis leaf appears as floral pattern and configured to a pinhole and eyehole. The Cannabis leaf configured with an eyehole or pinhole is used as an decorative article or an ornamental article.

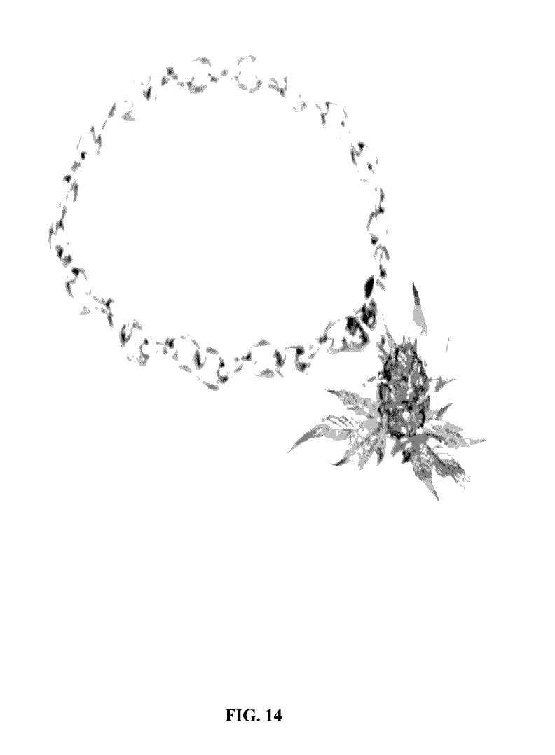

FIG. 14 illustrates photograph indicating the bracelet configured with a Cannabis decorative article comprising a3D molded Cannabis bud and Cannabis leaves, according to one embodiment herein. FIG. 14 illustrate the bracelet configured to 3D molded Cannabis bud and Cannabis leaves to be worn or used by an user for Cannabis based theme or party.

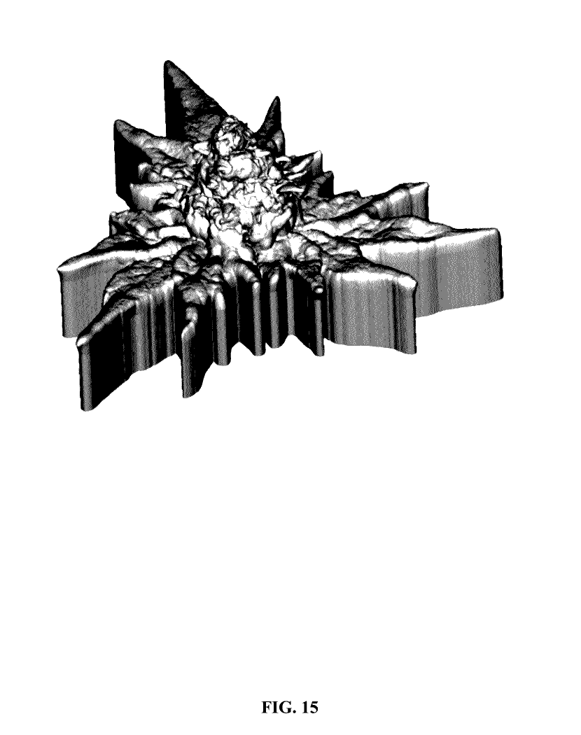

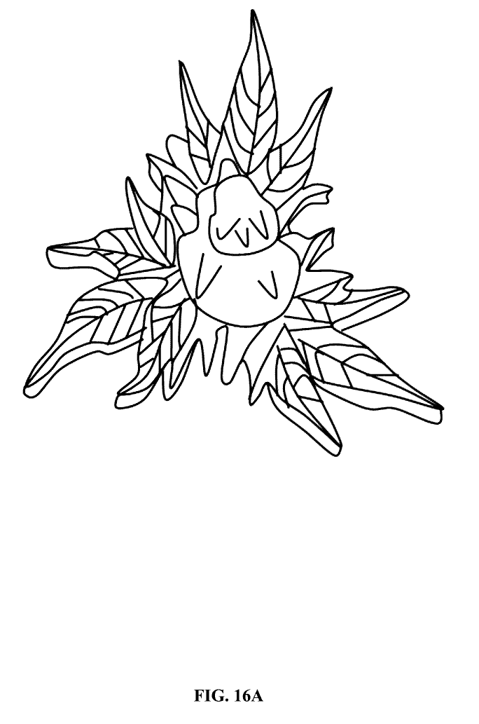

FIG. 15 illustrates photograph indicating a mold in a shape of Cannabis bud and Cannabis leaves, according to one embodiment herein. The mold illustrated in FIG. 15 is used as a Christmas ornament, souvenir, chocolate mold, candy mold, cookies mold and muffin mold.

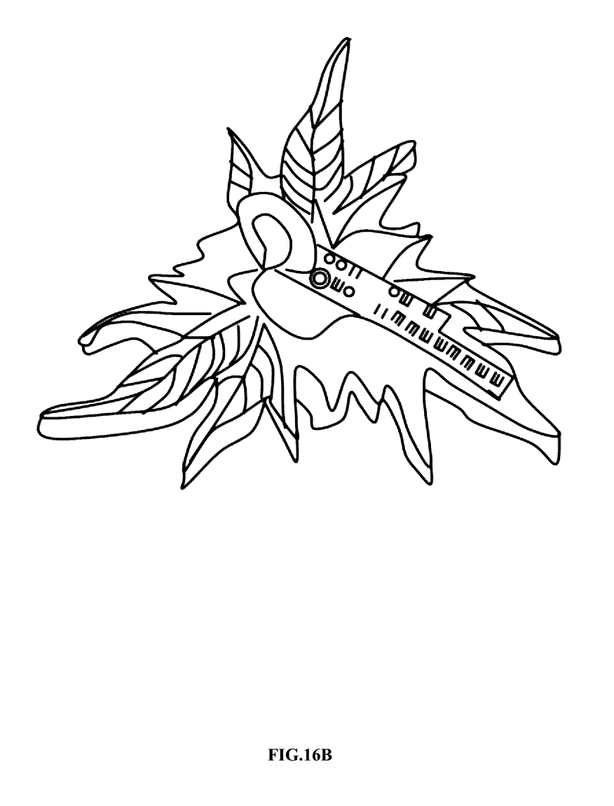

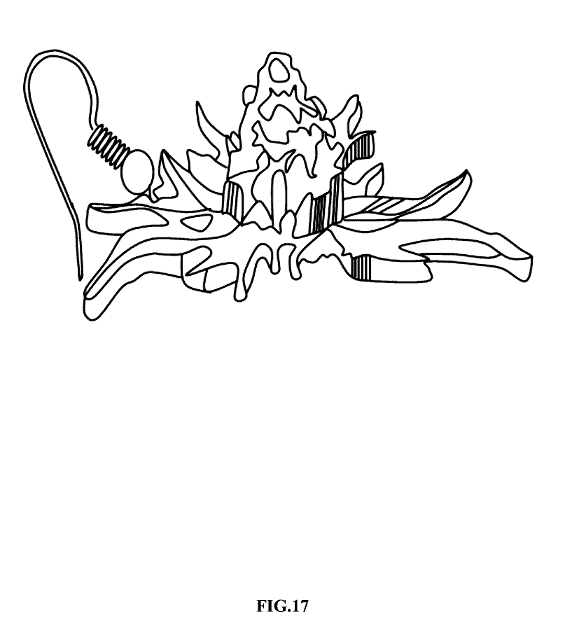

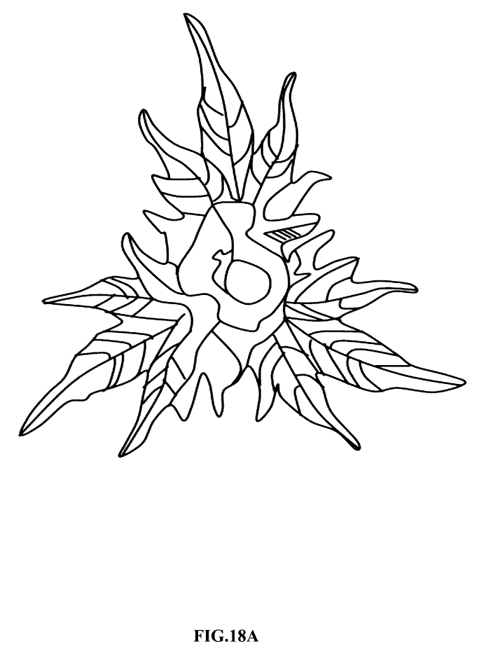

FIG. 16A and FIG. 16B illustrate an ornamental pendant comprising 3D molded Cannabis bud and Cannabis leaves, according to one embodiment herein. The FIG. 16 A illustrates the top perspective view of the ornamental pendant comprising 3D molded Cannabis bud and Cannabis leaves. The FIG. 16B illustrates the bottom view of the ornamental pendant comprising 3D molded Cannabis bud and Cannabis leaves.

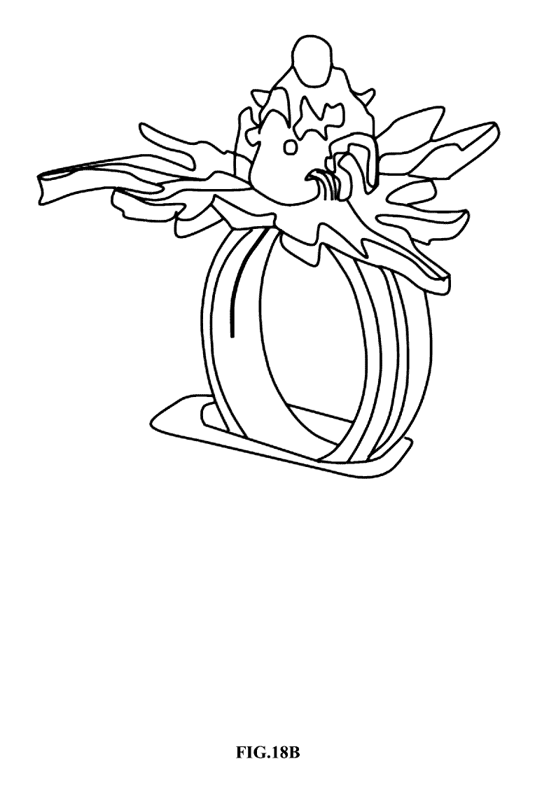

FIG. 17 illustrates an ornamental earring comprising 3D molded Cannabis bud and Cannabis leaves, according to one embodiment herein. FIG. 17 illustrates the Cannabis leaves and Cannabis bud in the earring. FIG. 17 also illustrates the hook configured to the circular structure in the 3D molded design for wearing the earring. The earring illustrated in FIG. 17 is worn by user for the Cannabis based themes or occasions.

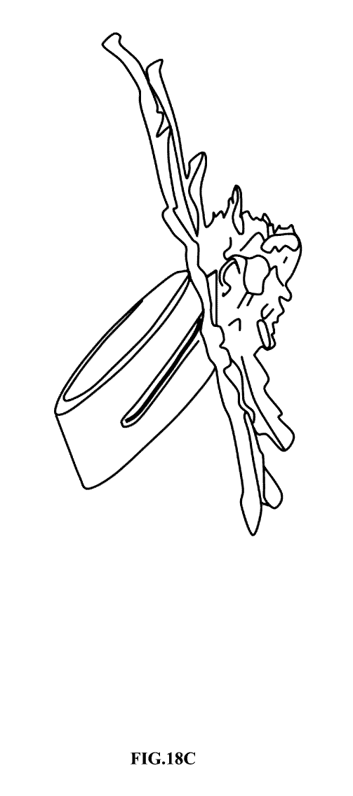

FIG. 18A-FIG. 18C illustrates different views of an ornamental finger ring comprising 3D molded Cannabis bud and Cannabis leaves, according to one embodiment herein. FIG. 18A illustrates top view of the ornamental finger ring. FIG. 18B illustrates the side perspective view of ornamental finger ring comprising Cannabis leaves and Cannabis bud in the fingering. FIG. 18C illustrates the other side perspective view of the ornamental finger ring comprising Cannabis leaves and the Cannabis bud in the fingering. The Cannabis leaves are arranged in the form of floral pattern.

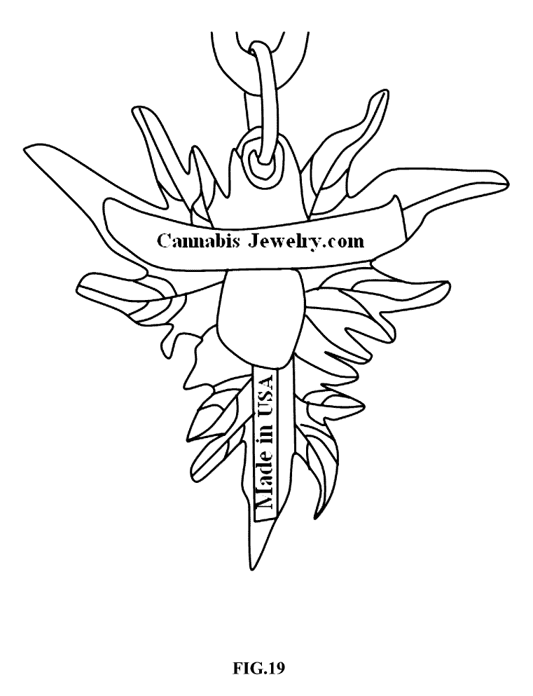

FIG. 19 illustrates a key chain comprising 3D molded Cannabis leaves, according to one embodiment herein. The key chain comprising 3D molded Cannabis leaves are arranged in a floral pattern.

According to one embodiment herein, 3D molded Cannabis bud and 3D molded Cannabis leaves are molded with a women's finger ring or men's finger ring in plurality of designs. The material for fabrication of finger ring comprising 3D molded Cannabis bud and 3D molded Cannabis leaves are metal or pewter. Precious stones or semi-precious stones are included based on user or wearer preferences.

According to one embodiment herein, 3D molded Cannabis bud and 3D molded Cannabis leaves are molded for fabrication of ear rings of plurality of designs. The material for fabrication of ear ring comprising 3D molded Cannabis bud and 3D molded Cannabis leaves are metal or pewter. Precious stones or semi-precious stones are included based on user or wearer preferences.

According to one embodiment herein, 3D molded Cannabis bud and 3D molded Cannabis leaves are molded for fabrication of necklaces of plurality of designs. The material for fabrication of necklaces comprising 3D molded Cannabis bud and 3D molded Cannabis leaves are metal or pewter. Precious stones or semi-precious stones are included based on user or wearer preferences.

According to one embodiment herein, 3D molded Cannabis bud and 3D molded Cannabis leaves are molded for fabrication of bracelets of plurality of designs. The material for fabrication of necklaces comprising 3D molded Cannabis bud and 3D molded Cannabis leaves are metal or pewter. Precious stones or semi-precious stones are included based on user or wearer preferences.

According to one embodiment herein, 3D molded Cannabis bud and 3D molded Cannabis leaves are molded for fabrication of candles of plurality of designs, shapes, sizes, colors. The candles are scented or unscented based on user preference.

According to one embodiment herein, the jewelry boxes are fabricated in the shape of 3D Cannabis bud. The 3D molded Cannabis leaves are adhered to the 3D Cannabis bud. The jewelry boxes are decorated with 3D molded Cannabis bud.

According to one embodiment herein, the 3D molded Cannabis bud and 3D molded Cannabis leaves are used for the fabrication of Christmas ornaments with plurality of shapes, sizes and designs. The 3D molded Cannabis bud is fabricated hollow or solid based on user preference. The 3D molded Cannabis bus is fabricated with glass, metal, plastic, and alloys of metal. The precious and semi-precious stones are embedded in the 3D molded Cannabis bud and 3D molded Cannabis leaves based on user preferences.

According to one embodiment herein, the one piece 3D molded Cannabis bud and 3D molded Cannabis leaves of plurality of sizes and shapes are attached or configured with an internal pin comprising eyelet (pinhole). The eyelet (pinhole) is fabricated with a wire. The pinhole is connected with chains, pendants, key chains and the like. The eyelet of the internal pin is molded or welded behind the leaves in different places of the 3D Cannabis bud or 3D Cannabis leaves. The eyelet (pinhole) is molded or inserted into 3D molded Cannabis bud or 3D molded Cannabis leaves to allow the user to attach key chain, a necklace, earrings and decoration articles. The 3D molded Cannabis bud earring comprises a hollow one piece or single piece bud.

According to one embodiment herein, based on user preference the one piece 3D molded Cannabis bud or the two piece 3D molded Cannabis bud and the 3D molded Cannabis leaves are configured to plurality of decorative articles or jewelry articles.

According to one embodiment herein, the one piece 3D molded Cannabis bud or the two piece 3D molded Cannabis bud are configured or attached to 3D molded Cannabis leaves to obtain a 3D molded Cannabis bud and leaf structure. The 3D molded Cannabis bud and leaf structure is attached or configured to plurality of decorative articles, jewelry articles based on user preference. The 3D molded Cannabis bus and leaf structure are attached or configured to plurality of articles by an internal pin with an eyelet or by an application of epoxies and glues.

According to one embodiment herein, the internal pin and eyelet are either molded or inserted in to the one piece 3D molded Cannabis bid or in the two piece 3D molded Cannabis bud. The eyelet of the internal pin is exposed to attach the one piece 3D molded Cannabis bud or the two piece 3D molded Cannabis bud with plurality of decorative articles or jewelry articles based on user preference. The pluralities of articles are key chains, necklace, finger ring, earring, eye glass, decorative hanging articles and the like. The 3D molded Cannabis bud earring comprises a hollow one piece or single piece bud.

According to one embodiment herein, the user collects one piece 3D molded Cannabis bud or the two piece 3D molded Cannabis bud of different sizes based on preference. The one piece 3D molded Cannabis bud or the two piece 3D molded Cannabis bud are configured or attached to decorative articles or jewelry articles. The internal pin and the eyelet are molded or inserted into the Cannabis bud for attaching a plurality of decorative articles or jewelry articles based on user preference. The decorative structures fabricated with Cannabis plant parts (leaf, flower, bud and the like) are light lamp, key chain, Christmas ornaments, souvenir, chocolate mold, candy mold, cookies mold and muffin mold. The Christmas ornaments are suspended or hanged in plurality of ways selected from a group consisting of hook, string. The hook and string are attached to the bud comprising pinhole.

The ornamental structures fabricated with Cannabis plant parts (leaf, flower, bud and the like) are finger ring, earring, chain pendant, bracelet charms. The user interchanges the one piece 3D molded Cannabis bud or the two piece 3D molded Cannabis bud between different attachment components. Small 3D molded Cannabis bud and leaf combinations are attached to decorative articles selected from a group consisting of ear rings and finger rings.

According to one embodiment herein, the 3D molded Cannabis bud, the 3D molded Cannabis leaves and the 3D molded Cannabis flower are fabricated from the material selected from a group consisting of plastics, polymers, glass, rubber, precious metals and non-precious metals. The metals are selected from a group consisting of steel, aluminum, precious metals (silver, gold and platinum).

According to one embodiment herein, the 3D molded Cannabis bud, 3D molded Cannabis leaves and other parts of Cannabis plant are utilized for fabrication of Christmas ornaments, candles (scented or unscented) shaped in the form of Cannabis leaf and Cannabis bud, lamps, decorative boxes or jewelry boxes, chocolate mold, candy mold, cookies mold and muffin mold shaped in the form of 3D molded Cannabis bud or 3D molded Cannabis leaves.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims submitted below. The scope of the invention will be ascertained by the following claims.

What is claimed is:

1. A 3D molded article of manufacture, comprises:
a 3D molded bud of a plant;
a 3D molded flower of the plant; and
a plurality of 3D molded leaves of the plant;
wherein the 3D molded bud of the plant, the 3D molded flower of the plant and the plurality of 3D molded leaves of the plant are assembled to form decorative articles or structures and ornamental articles or jewelry structures, and wherein the plant is a Cannabis plant or a Hemp plant, and wherein the 3D molded bud of the plant, the 3D molded flower of the plant and the plurality of 3D molded leaves of the plant are configured with an internal pin comprising an eyelet or pinhole, and wherein the article is obtained after fastening or joining the 3D molded bud of the plant, the 3D molded flower of the plant and the plurality of 3D molded leaves of the plant with an internal pin comprising an eyelet or pinhole.

2. The 3D molded article according to claim 1, wherein the 3D molded bud of the plant, the 3D molded flower of the plant and the plurality of 3D molded leaves of the plant are molded or fabricated from one or more materials selected from a group consisting of polymer, glass, rubber, silicone, clay, porcelain, wax, steel, pewter, aluminum, bronze, copper, precious metals, and wherein the precious metals are selected from a group consisting of silver, gold and platinum, and wherein the materials are added in a predetermined amount for molding, and wherein the predetermined amount of materials is in a range of 1 gram-5000 grams.

3. The 3D molded article according to claim 1, wherein the decorative articles are selected from a group consisting of light lamp, key chain, Christmas ornaments, souvenir articles, chocolate mold, candy mold, cookies mold and muffin mold.

4. The 3D molded article according to claim 1, wherein the ornamental articles or jewelry articles are selected from a group consisting of finger ring, earring, chain pendant and bracelet.

5. The 3D molded article according to claim 1, wherein the 3D molded Cannabis bud is selected from a group consisting of two piece hollow Cannabis bud and a one piece solid Cannabis bud.

6. The 3D molded article according to claim 1, wherein the two piece hollow buds of the plant are attached or joined by a fastening mechanism selected from a group consisting of screw mechanism, hinged clip mechanism, snap on mechanism and push fit mechanism.

7. The 3D molded article according to claim 1, wherein the internal pin is fabricated from plastic or metal, and wherein the dimension of internal pin is in a range of 0.5 inch-1.5 inch.

8. The 3D molded article according to claim 1, the 3D molded bud of the plant, the 3D molded flower of the plant and the plurality of 3D molded leaves of the plant are fastened or attached through welding or adhesive agent.

9. A method of fabricating 3D molded article, the method comprising the steps of:
molding a bud of a plant;
molding a flower of the plant; and
molding a plurality of leaves of the plant;
wherein a silicone rubber mold or a vulcanized back rubber mold is used for fabricating the bud of the plant, the flower of the plant and the plurality of the leaves of the plant, wherein the 3D molded bud of the plant, the 3D molded flower of the plant and the plurality of 3D molded leaves of the plant are assembled to form decorative articles or structures and ornamental articles or jewelry structures, and wherein the plant is a Cannabis plant or a Hemp plant, and wherein the 3D molded bud of the plant, the 3D molded flower of the plant and the plurality of 3D molded leaves of the plant are configured with an internal pin comprising an eyelet or pinhole, and wherein the article is obtained after fastening or joining the 3D molded bud of the plant, the 3D molded flower of the plant and the plurality of 3D molded leaves of the plant with an internal pin comprising an eyelet or pinhole.

10. The method according to claim 9, wherein the 3D molded bud of the plant, the 3D molded flower of the plant and the plurality of 3D molded leaves of the plant are molded or fabricated from one or more materials selected from a group consisting of polymer, glass, rubber, silicone, clay, porcelain, wax, steel, pewter, aluminum, bronze, copper, precious metals, and wherein the precious metals are selected from a group consisting of silver, gold and platinum, and wherein the materials are added in a predetermined amount for molding, and wherein the predetermined amount of materials is in a range of 1 gram-5000 grams.

11. The method according to claim 9, wherein the decorative articles are selected from a group consisting of light lamp, key chain, Christmas ornaments, souvenir articles, chocolate mold, candy mold, cookies mold and muffin mold.

12. The method according to claim 9, wherein the ornamental articles or jewelry articles are selected from a group consisting of finger ring, earring, chain pendant and bracelet.

13. The method according to claim 9, wherein the 3D molded Cannabis bud is selected from a group consisting of two piece hollow Cannabis bud and a one piece solid Cannabis bud.

14. The method according to claim 9, wherein the two piece hollow buds of the plant are attached or joined by a fastening mechanism selected from a group consisting of screw mechanism, hinged clip mechanism, snap on mechanism and push fit mechanism.

15. The method according to claim 9, wherein the internal pin is fabricated from plastic or metal, and wherein the dimension of internal pin is in a range of 0.5 inch-1.5 inch.

16. The method according to claim 9, the 3D molded bud of the plant, the 3D molded flower of the plant and the plurality of 3D molded leaves of the plant are fastened or attached by welding or adhesive agent.
